(19) United States
(12) Patent Application Publication
(10) Pub. No.: US 2025/0097812 A1
(43) Pub. Date: Mar. 20, 2025

(54) SYSTEMS AND METHODS FOR RECEIVING ROUTE SELECTION POLICIES WITH CORE NETWORK TYPE INDICATORS

(71) Applicant: Verizon Patent and Licensing Inc., Basking Ridge, NJ (US)

(72) Inventors: Sudhakar Reddy PATIL, Flower Mound, TX (US); Samirkumar PATEL, Middlesex, NJ (US); Lixia YAN, Basking Ridge, NJ (US); Raquel MORERA SEMPERE, Weehawken, NJ (US)

(73) Assignee: Verizon Patent and Licensing Inc., Basking Ridge, NJ (US)

(21) Appl. No.: 18/469,191

(22) Filed: Sep. 18, 2023

(51) Int. Cl. H04W 40/02; H04L 45/302; H04W 28/02

(52) U.S. Cl. CPC H04W 40/02; H04L 45/306; H04W 28/0226

(57) ABSTRACT

In some implementations, a device may generate a user equipment (UE) route selection policy (URSP) rule that indicates a route selection descriptor and a traffic descriptor, and one of the route selection descriptor or the traffic descriptor indicates a core network (CN) type associated with the URSP rule. The device may transmit the URSP rule.

### BACKGROUND

Wireless communication systems are widely deployed to provide various telecommunication services such as telephony, video, data, messaging, and broadcasts. A wireless network may include one or more network nodes that support communication for wireless communication devices, such as a user equipment (UE). A UE may communicate with a network node via downlink communications and uplink communications. “Downlink” (or “DL”) refers to a communication link from the network node to the UE, and “uplink” (or “UL”) refers to a communication link from the UE to the network node.

### BRIEF DESCRIPTION OF THE DRAWINGS

FIG. 1 is a diagram of an example associated with a provisioning of a user equipment (UE) route selection policy (URSP).

FIG. 2 is a diagram of an example of traffic descriptor parameters.

FIG. 3 is a diagram of an example of route selection descriptor parameters.

FIG. 4 is a diagram of an example associated with receiving route selection policies with core network (CN) type indicators.

FIG. 5 is a diagram of an example environment in which systems and/or methods described herein may be implemented.

FIG. 6 is a diagram of example components of one or more devices of FIG. 5.

FIG. 7 is a flowchart of an example process associated with receiving route selection policies with CN type indicators.

### DETAILED DESCRIPTION OF EXAMPLE EMBODIMENTS

The following detailed description of example implementations refers to the accompanying drawings. The same reference numbers in different drawings may identify the same or similar elements.

A URSP may be a policy used by a UE for routing outgoing traffic. Traffic may be routed to an established protocol data unit (PDU) session in accordance with the URSP. Traffic may be offloaded to a non-Third Generation Partnership Project (3GPP) (non-3GPP) access outside a PDU session in accordance with the URSP. Traffic may trigger an establishment of a new PDU session in accordance with the URSP. The URSP may be a set of one or more URSP rules. URSP rules may be defined for a Fifth Generation (5G) core network (CN). URSP rules may also be used in an Evolved Packet System (EPS).

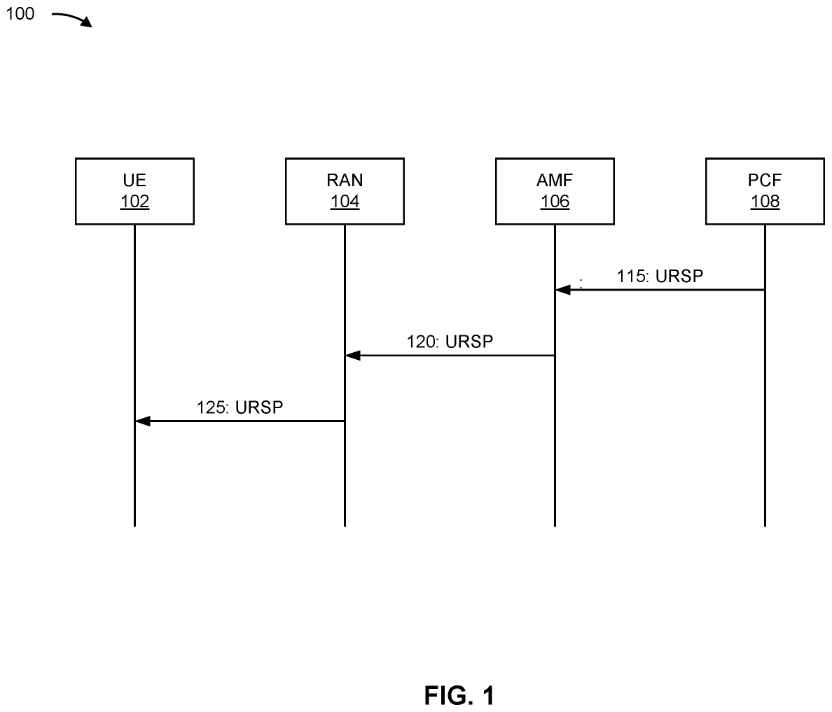

FIG. 1 is a diagram of an example 100 associated with a provisioning of a URSP. As shown in FIG. 1, example 100 includes a UE 102, a radio access network (RAN) 104, an access and mobility management function (AMF) 106, and a policy control function (PCF) 108.

As shown by reference number 115, the PCF 108 may transmit, to the AMF 106, a URSP. The URSP may include URSP rules related to traffic routing (or data routing). As shown by reference number 120, the AMF 106 may forward the URSP to the RAN 104. As shown by reference number 125, the RAN 104 may forward the URSP to the UE 102. The UE 102 may use the URSP for routing outgoing traffic.

As indicated above, FIG. 1 is provided as an example. Other examples may differ from what is described with regard to FIG. 1.

When a UE is registered to an Evolved Packet Core (EPC) via a 3GPP access and not registered to any CN via a non-3GPP access, or the UE is registered to the EPC via the 3GPP access and registered to the EPC via the non-3GPP access, the UE may use access network discovery and selection function (ANDSF) rules and radio access network (RAN) rules, if available at the UE, for all uplink user data for which there is one or more applicable ANDSF rule or RAN rule, except for rules and parameters related to a non-3GPP access node selection. Further, when the UE is registered to the EPC via the 3GPP access and not registered to any CN via the non-3GPP access, or the UE is registered to the EPC via the 3GPP access and registered to the EPC via the non-3GPP access, the UE may use URSP rules, if available at the UE, to derive parameters to be used in EPS for all uplink user data for which there is no applicable ANDSF rule or RAN rule, except for the rules and parameters related to the non-3GPP access node selection and there is no applicable UE local configuration.

Regarding the use of URSP in EPS, when the UE supports both an S1 mode (e.g., a single UE usage setting at the UE may apply to both a 5G system and EPS) and an N1 mode (e.g., the UE is allowed access to a 5G core network (5GCN) via a 5G access network), the UE does not have preconfigured rules for associating an application to either a packet data network (PDN) connection or a non-seamless non-3GPP offload (e.g., no rules are available in a UE local configuration and no ANDSF rules are applicable for the application), and the UE is provisioned with URSP, when in the S1 mode, the UE may use a matching URSP rule, if available, to derive parameters, e.g. access point name (APN), using a mapping between parameters in the URSP rules and parameters used for PDN connection establishment. The URSP rule with the derived EPS parameters may be used for associating the application to either the PDN connection or the non-seamless non-3GPP offload. A precedence of the URSP rule may be reused in EPS.

When a route selection descriptor for the matching URSP rule includes at least one parameter not applicable in EPS, the UE may not use the route selection descriptor and proceed to evaluate the route selection descriptor with a next lowest precedence value. Further, when the route selection descriptor for the matching URSP rule includes one or more parameters ignored in EPS, the UE may evaluate the route selection descriptor without considering the one or more parameters ignored in EPS.

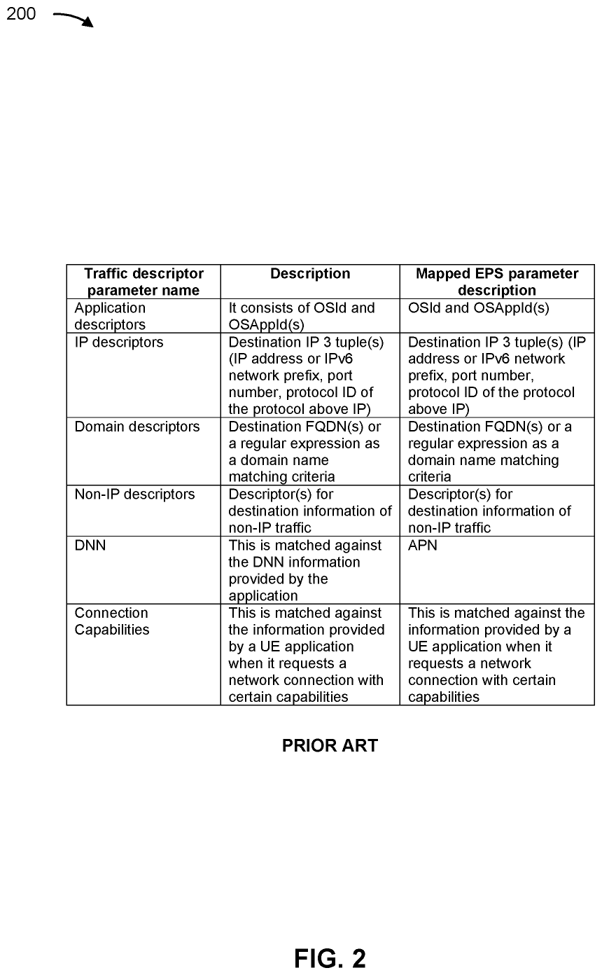

FIG. 2 is a diagram of an example 200 of traffic descriptor parameters, which may be indicated in a URSP.

As shown in FIG. 2, a plurality of traffic descriptor parameters may be defined for the URSP. A traffic descriptor parameter may be associated with a mapped EPS parameter, which may or may not be the same as the traffic descriptor parameter. The traffic descriptor parameter may include application descriptors, which may include an operating system (OS) identifier (OSId) and OS application identifiers (OSAppId(s)). The traffic description parameter may include Internet Protocol (IP) descriptors, which may include destination IP 3 tuple(s) (IP address of IP version 6 (IPv6) network prefix, port number, and protocol identifier of a protocol above IP). The traffic description parameter may include domain descriptors, which may include destination fully qualified domain name(s) (FQDN(s) or a regular expression as a domain name matching criteria.

The traffic description parameter may include non-IP descriptors, which may include descriptor(s) for destination information of non-IP traffic. The traffic description parameter may include a data network name (DNN), which may be matched against DNN information provided by an application. The mapped EPS parameter for the DNN may be an APN. The traffic description parameter may include connection capabilities, which may be matched against information provided by a UE application when requesting a network connection with certain capabilities.

As indicated above, FIG. 2 is provided as an example. Other examples may differ from what is described with regard to FIG. 2.

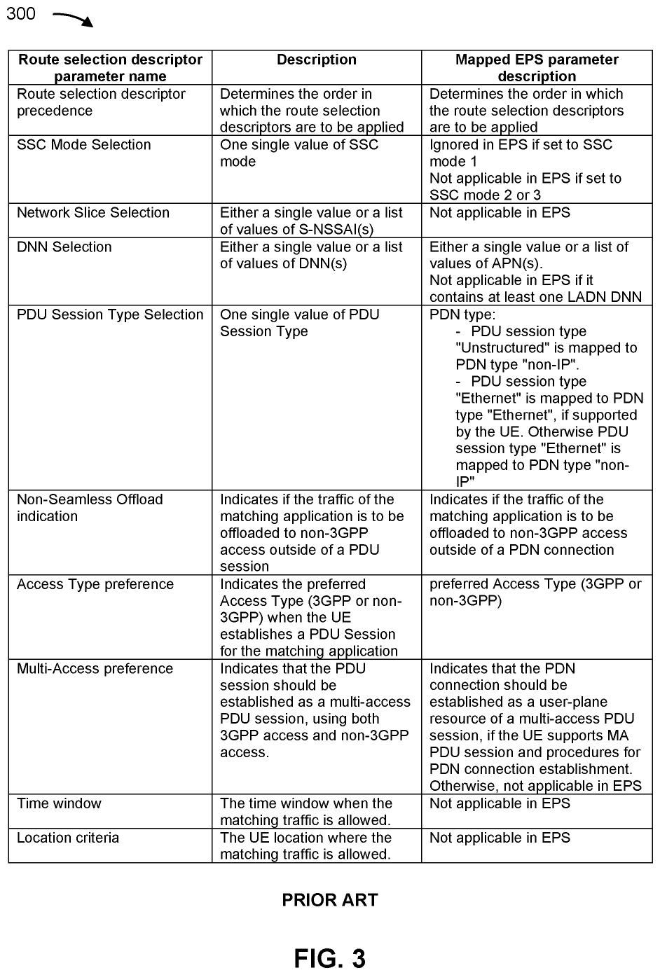

FIG. 3 is a diagram of an example 300 of route selection descriptor parameters, which may be indicated in a URSP.

As shown in FIG. 3, a plurality of route selection descriptor parameters may be defined for the URSP. A route selection descriptor parameter may be associated with a mapped EPS parameter, which may or may not be the same as the route selection descriptor parameter. The route selection descriptor parameter may include a route selection descriptor precedence, which may determine an order in which route selection descriptors are to be applied. The route selection descriptor parameter may include a session and service continuity (SSC) mode selection, which may correspond to one single value of SSC mode. The mapped EPS parameter for the SSC mode selection may be ignored in EPS when SSC mode 1 is set, or may not be applicable in EPS when SSC mode 2 or 3 is set. The route selection descriptor parameter may include a network slice selection, which may correspond to a single value or a list of values of single network slice selection assistance information (S-NSSAI(s)). The mapped EPS parameter for the network slice selection may not be applicable in EPS.

The route selection descriptor parameter may include a DNN selection, which may correspond to a single value or a list of values of DNN(s). The mapped EPS parameter for the DNN selection may be a single value or a list of values of APN(s). The route selection descriptor parameter may include a PDU session type selection, which may correspond to one single value of PDU session type. The route selection descriptor parameter may include a non-seamless offload indication, which may indicate when traffic of a matching application is to be offloaded to non-3GPP access outside of a PDU session. The route selection descriptor parameter may include an access type preference, which may indicate a preferred access type (e.g., 3GPP or non-3GPP) when the UE establishes a PDU session for the matching application. The route selection descriptor parameter may include a multi-access preference, which may indicate that a PDU session should be established as a multi-access PDU session, using both 3GPP access and non-3GPP access. The mapped EPS parameter for the multi-access preference may not be applicable in EPS.

The route selection descriptor parameter may include a time window, which may correspond to a time window when matching traffic is allowed. The mapped EPS parameter for the time window may not be applicable in EPS. The route selection descriptor parameter may include location criteria, which may correspond to a UE location where matching traffic is allowed. The mapped EPS parameter for the location criteria may not be applicable in EPS.

As indicated above, FIG. 3 is provided as an example. Other examples may differ from what is described with regard to FIG. 3.

In a DNN/APN and slice design of an operator, a UE may use DNN1 (e.g., non-default DNN/APN) when the UE is in standalone (SA) over a slice 1 (e.g., non-default slice). DNN1 may not be supported in a default slice or any other slice except for slice 1. When the UE is in EPC, the operator may design the service such that an equivalent APN to DNN1 may be used in EPC.

A URSP rule may be designed accordingly. For example, the URSP rule may indicate a precedence value. The URSP rule may indicate a traffic descriptor. The URSP rule may indicate a first route selection descriptor (RSD1). The URSP rule may indicate a precedence value of RSD1. RSD1 may contain an attribute that is not applicable in EPS, and thus may not be used when the UE is in EPS. In this case, the UE may evaluate a next route selection descriptor, such as a second route selection descriptor (RSD2). When slice 1 is not in an allowed network slice selection assistance information (NSSAI), the UE may evaluate RSD2. The URSP rule may indicate a precedence value of RSD1. An S-NSSAI may be set to slice 1, and a DNN may be set to DNN1. The URSP rule may indicate RSD2. RSD2 may be used when the UE is connected to a 5GCN but slice 1 is not in the allowed NSSAI, or when the UE is connected to EPS as the S-NSSAI is not allowed in EPS. The URSP rule may indicate a precedence value of RSD2. A DNN may be set to DNN1.

When the UE is connected to the 5GCN and slice 1 is not part of the allowed NSSAI, RSD2 may be used to establish a PDU session when a match occurs for the URSP rule. A PDU session request may not indicate a slice ID, but may indicate DNN1. Since the DNN1 in RSD2 may only be supported in slice 1, a network may map the PDU session request with DNN1 to slice 1. However, since slice 1 is not part of the allowed NSSAI, the PDU session request may not be accepted, which may result in a waste of resources (e.g., PDU session request over non-access stratum (NAS) signaling).

The URSP rule may include RSD2 because a route selection descriptor without a slice ID may be needed for an application to request the PDU session with DNN1. However, since no capability exists to explicitly state that the URSP rule is applicable in EPS, a route selection descriptor may also be used when the UE is registered in the 5GCN when a slice is not in the allowed NSSAI. A URSP rule structure, which may include the route selection descriptor, does not have sufficiently flexibility for a network to specify which rules should be applied when the UE is in the 5GCN and which rules should be applied when the UE is in EPS, which may result in unnecessary signaling over an air interface and unwanted UE behavior.

In some implementations, in a URSP rule, a route selection descriptor may include a new attribute, which may enable the ability to explicitly specify whether the route selection descriptor is associated with 5GCN or whether the route selection descriptor is associated with EPS, rather than relying on an applicability of an attribute. The route selection descriptor may indicate a CN type with a value of “5GCN” for a 5GCN or a value of “EPS” for an EPS core network. The new attribute in the route selection descriptor may enable the operator to explicitly specify which URSP rules are applied to 5GCN and which URSP rules are applied to EPS. As a result, by including the new attribute in the route selection descriptor, the UE may avoid unnecessary signaling (e.g., when the UE is connected to the 5GCN but a slice is not part of an allowed NSSAI), which may improve an overall performance of the UE and the network.

Alternatively, in a URSP rule, a traffic descriptor may include a new attribute, which may enable to explicitly specify whether the traffic descriptor is associated with 5GCN or whether the traffic descriptor is associated with EPS, rather than relying on the applicability of the attribute. The traffic descriptor may indicate the CN type with the value of “5GCN” for the 5GCN or the value of “EPS” for the EPS core network. The new attribute in the traffic descriptor may enable the operator to explicitly specify which URSP rules are applied to 5GCN and which URSP rules are applied to EPS.

As an example, in the URSP rule, RSD1 may be associated with slice 1, DNN1, and 5GCN. RSD2 may be associated with DNN1 and EPS. A third route selection descriptor (RSD3) may be associated with DNN1 and 5GCN. When a UE is connected to a 5GCN but slice 1 is not in an allowed NSSAI, the UE may not apply RSD1 because slice 1 is not part of the allowed NSSAI. The UE may not apply RSD2 because the UE is not associated with EPS. The UE may apply RSD3 because the UE is connected to the 5GCN and slice 1 is not part of the allowed NSSAI. Since the UE is able to apply RSD3, the UE does not unnecessarily send a PDU session request based on RSD2. As a result, unnecessary signaling over the air may be reduced for the UE, which may improve an overall performance of the UE and the network.

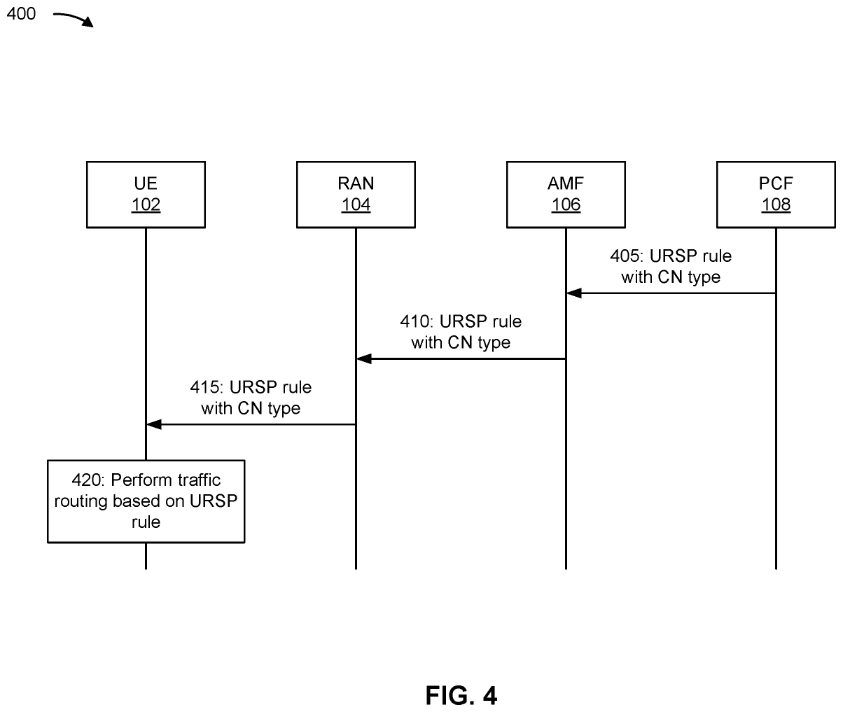

FIG. 4 is a diagram of an example 400 associated with receiving route selection policies with CN type indicators. As shown in FIG. 4, example 400 includes a UE 102, a RAN 104, an AMF 106, and a PCF 108.

As shown by reference number 405, the PCF 108 may transmit, to the AMF 106, a URSP rule. The PCF 108 may generate the URSP rule to indicate a route selection descriptor and a traffic descriptor. The route selection descriptor or the traffic descriptor may indicate a CN type associated with the URSP rule. The URSP rule may be related to traffic routing (or data routing). The URSP rule may be based on subscription information. The URSP rule may indicate a route selection descriptor and a traffic descriptor. The route selection descriptor may indicate an S-NSSAI and/or a DNN. As shown by reference number 410, the AMF 106 may forward the URSP rule to the RAN 104. As shown by reference number 415, the RAN 104 may forward the URSP rule to the UE 102. The UE 102 may receive the URSP rule from the PCF 108 via the RAN 104 and the AMF 106. The UE 102 may receive the URSP rule as part of a configuration update.

In some implementations, the route selection descriptor may indicate the CN type associated with the URSP rule. The CN type in the route selection descriptor may indicate a value associated with a 5GCN. In this case, the URSP rule may be associated with the 5GCN. The CN type in the route selection descriptor may indicate a value associated with an EPS. In this case, the URSP rule may be associated with the EPS. Alternatively, the traffic descriptor may indicate the CN type associated with the URSP rule. The CN type in the traffic descriptor may indicate the value associated with the 5GCN. In this case, the URSP rule may be associated with the 5GCN. The CN type in the traffic descriptor may indicate the value associated with the EPS. In this case, the URSP rule may be associated with the EPS.

As shown by reference number 420, the UE 102 may use the URSP rule for routing outgoing traffic. The UE may perform traffic routing based on the URSP rule. The UE, when performing the traffic routing, may establish a PDN session for a matching application based on the CN type. In other words, the UE may establish the PDN session for the matching application based on 5GCN. Alternatively, the UE may establish the PDN session for the matching application based on EPS.

In some implementations, when the UE is connected to EPS, a route selection descriptor that indicates a CN type of EPS may be used by the UE to establish the PDU session. When the UE is connected to the 5GCN, a route selection descriptor that indicates a CN type of 5GCN may or may not be used by the UE to establish a PDU session. For example, even though the UE is connected to the 5GCN and the route selection descriptor indicates the CN type of 5GCN, the UE may be unable to use the route selection descriptor when a slice associated with the route selection descriptor is not in an allowed NSSAI. In this case, the UE may evaluate a route selection descriptor that indicates the CN type of 5GCN and is not associated with a network slice selection. In other words, the UE may evaluate a route selection descriptor that indicates the CN type of 5GCN, and the route selection descriptor does not indicate an S-NSSAI. When the UE is not permitted to use a particular route selection descriptor, the UE may not attempt to establish the PDU session using that route selection descriptor, which may reduce unnecessary NAS signaling by the UE. By indicating the CN type for each route selection descriptor, the UE may be able to determine whether a particular route selection descriptor may or may not be applied for establishing the PDU session.

In some implementations, by implementing the CN type in the route selection descriptor, a network and/or the UE may support a capability to explicitly state whether a certain URSP rule is applicable to 5GCN or EPS, which may allow an appropriate route selection descriptor to be used by the UE for establishing the PDN session. A URSP rule structure may be sufficiently flexible, such that the network may be able to specify which URSP rules should be applied when the UE is in 5GCN and which URSP rules should be applied when the UE is in EPS. The URSP rule structure may include an additional field in the route selection descriptor to explicitly indicate whether a selection of the PDU session should be in 5GCN or EPS. Alternatively, the URSP rule structure may include an additional field in the traffic descriptor to explicitly indicate whether the URSP rule should be used in 5GCN or EPS. As a result, the UE may avoid unnecessary NAS signaling over an air interface and/or unwanted UE behavior, thereby improving an overall performance of the UE.

As indicated above, FIG. 4 is provided as an example. Other examples may differ from what is described with regard to FIG. 4. The number and arrangement of devices shown in FIG. 4 are provided as an example. In practice, there may be additional devices, fewer devices, different devices, or differently arranged devices than those shown in FIG. 4. Furthermore, two or more devices shown in FIG. 4 may be implemented within a single device, or a single device shown in FIG. 4 may be implemented as multiple, distributed devices. Additionally, or alternatively, a set of devices (e.g., one or more devices) shown in FIG. 4 may perform one or more functions described as being performed by another set of devices shown in FIG. 4.

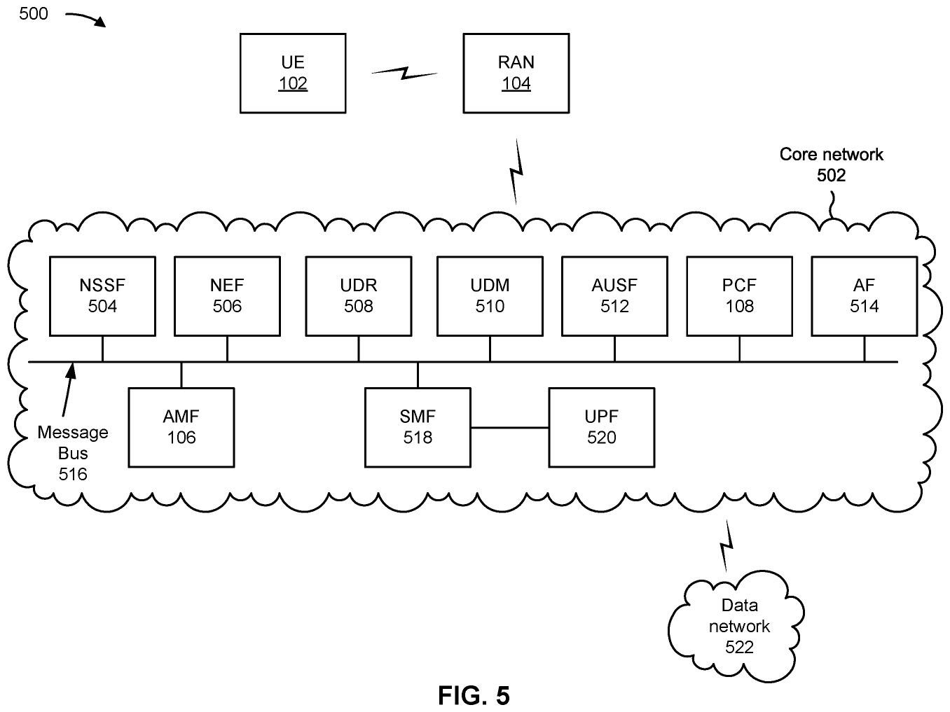

FIG. 5 is a diagram of an example environment 500 in which systems and/or methods described herein may be implemented. As shown in FIG. 5, example environment 500 may include a UE 102, a RAN 104, a core network 502, and a data network 522. Devices and/or networks of example environment 500 may interconnect via wired connections, wireless connections, or a combination of wired and wireless connections.

The UE 102 may include one or more devices capable of receiving, generating, storing, processing, and/or providing information, such as information described herein. For example, The UE 102 can include a mobile phone (e.g., a smart phone or a radiotelephone), a laptop computer, a tablet computer, a desktop computer, a handheld computer, a gaming device, a wearable communication device (e.g., a smart watch or a pair of smart glasses), a mobile hotspot device, a fixed wireless access device, customer premises equipment, an autonomous vehicle, or a similar type of device.

The RAN 104 may support, for example, a cellular radio access technology (RAT).

The RAN 104 may include one or more base stations (e.g., base transceiver stations, radio base stations, node Bs, eNodeBs (eNBs), gNodeBs (gNBs), base station subsystems, cellular sites, cellular towers, access points, transmit receive points (TRPs), radio access nodes, macrocell base stations, microcell base stations, picocell base stations, femtocell base stations, or similar types of devices) and other network entities that can support wireless communication for the UE 102. A base station may be a disaggregated base station. The disaggregated base station may be configured to utilize a protocol stack that is physically or logically distributed among two or more nodes, which may include a radio unit (RU), a distributed unit (DU), and a centralized unit (CU). The RAN 104 may transfer traffic between the UE 102 (e.g., using a cellular RAT), one or more base stations (e.g., using a wireless interface or a backhaul interface, such as a wired backhaul interface), and/or the core network 502. The RAN 104 may provide one or more cells that cover geographic areas.

In some implementations, the RAN 104 may perform scheduling and/or resource management for the UE 102 covered by the RAN 104 (e.g., the UE 102 covered by a cell provided by the RAN 104). In some implementations, the RAN 104 may be controlled or coordinated by a network controller, which may perform load balancing, network-level configuration, and/or other operations. The network controller may communicate with the RAN 104 via a wireless or wireline backhaul. In some implementations, the RAN 104 may include a network controller, a self-organizing network (SON) module or component, or a similar module or component. In other words, the RAN 104 may perform network control, scheduling, and/or network management functions (e.g., for uplink, downlink, and/or sidelink communications of the UE 102 covered by the RAN 104).

In some implementations, the core network 502 may include an example functional architecture in which systems and/or methods described herein may be implemented. For example, the core network 502 may include an example architecture of a fifth generation (5G) next generation (NG) core network included in a 5G wireless telecommunications system. While the example architecture of the core network 502 shown in FIG. 5 may be an example of a service-based architecture, in some implementations, the core network 502 may be implemented as a reference-point architecture and/or a 4G core network, among other examples.

As shown in FIG. 5, the core network 502 include a number of functional elements. The functional elements may include, for example, a network slice selection function (NSSF) 504, a network exposure function (NEF) 506, a unified data repository (UDR) 508, a unified data management (UDM) 510, an authentication server function (AUSF) 512, a PCF 108, an application function (AF) 514, an access and mobility management function (AMF) 106, a session management function (SMF) 518, and/or a user plane function (UPF) 520. These functional elements may be communicatively connected via a message bus 516. Each of the functional elements shown in FIG. 5 is implemented on one or more devices associated with a wireless telecommunications system. In some implementations, one or more of the functional elements may be implemented on physical devices, such as an access point, a base station, and/or a gateway. In some implementations, one or more of the functional elements may be implemented on a computing device of a cloud computing environment.

The NSSF 504 may include one or more devices that select network slice instances for the UE 102. The NSSF 504 may allow an operator to deploy multiple substantially independent end-to-end networks potentially with the same infrastructure. In some implementations, each slice may be customized for different services. The NEF 506 may include one or more devices that support exposure of capabilities and/or events in the wireless telecommunications system to help other entities in the wireless telecommunications system discover network services.

The UDR 508 may include one or more devices that provide a converged repository, which may be used by network functions to store data. For example, a converged repository of subscriber information may be used to service a number of network functions. The UDM 510 may include one or more devices to store user data and profiles in the wireless telecommunications system. The UDM 510 may generate authentication vectors, perform user identification handling, perform subscription management, and perform other various functions. The AUSF 512 may include one or more devices that act as an authentication server and support the process of authenticating the UE 102 in the wireless telecommunications system.

The PCF 108 may include one or more devices that provide a policy framework that incorporates network slicing, roaming, packet processing, and/or mobility management, among other examples. The AF 514 may include one or more devices that support application influence on traffic routing, access to the NEF 506, and/or policy control, among other examples. The AMF 106 may include one or more devices that act as a termination point for NAS signaling and/or mobility management, among other examples. The SMF 518 may include one or more devices that support the establishment, modification, and release of communication sessions in the wireless telecommunications system. For example, the SMF 518 may configure traffic steering policies at the UPF 520 and/or may enforce UE internet protocol (IP) address allocation and policies, among other examples. The UPF 520 may include one or more devices that serve as an anchor point for intra-RAT and/or inter-RAT mobility. The UPF 520 may apply rules to packets, such as rules pertaining to packet routing, traffic reporting, and/or handling user plane quality of service (QOS), among other examples. The message bus 516 may represent a communication structure for communication among the functional elements. In other words, the message bus 516 may permit communication between two or more functional elements.

The data network 522 may include one or more wired and/or wireless data networks. For example, the data network 522 may include an IP multimedia subsystem (IMS), a public land mobile network (PLMN), a local area network (LAN), a wide area network (WAN), a metropolitan area network (MAN), a private network such as a corporate intranet, an ad hoc network, the Internet, a fiber optic-based network, a cloud computing network, a third party services network, an operator services network, and/or a combination of these or other types of networks.

The number and arrangement of devices and networks shown in FIG. 5 are provided as an example. In practice, there may be additional devices and/or networks, fewer devices and/or networks, different devices and/or networks, or differently arranged devices and/or networks than those shown in FIG. 5. Furthermore, two or more devices shown in FIG. 5 may be implemented within a single device, or a single device shown in FIG. 5 may be implemented as multiple, distributed devices. Additionally, or alternatively, a set of devices (e.g., one or more devices) of example environment 500 may perform one or more functions described as being performed by another set of devices of example environment 500.

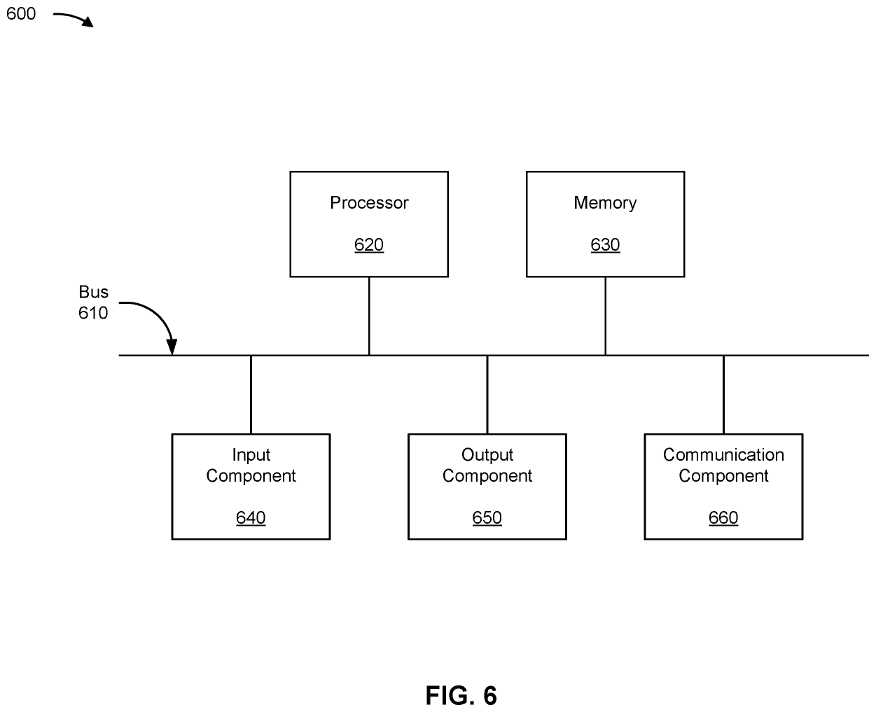

FIG. 6 is a diagram of example components of a device 600 associated with receiving route selection policies with CN type indicators. The device 600 may correspond to a UE (e.g., UE 102), a RAN (e.g., RAN 104), an AMF (e.g., AMF 106), or a PCF (e.g., PCF 108). In some implementations, the UE may include one or more devices 600 and/or one or more components of the device 600. As shown in FIG. 6, the device 600 may include a bus 610, a processor 620, a memory 630, an input component 640, an output component 650, and/or a communication component 660.

The bus 610 may include one or more components that enable wired and/or wireless communication among the components of the device 600. The bus 610 may couple together two or more components of FIG. 6, such as via operative coupling, communicative coupling, electronic coupling, and/or electric coupling. For example, the bus 610 may include an electrical connection (e.g., a wire, a trace, and/or a lead) and/or a wireless bus. The processor 620 may include a central processing unit, a graphics processing unit, a microprocessor, a controller, a microcontroller, a digital signal processor, a field-programmable gate array, an application-specific integrated circuit, and/or another type of processing component. The processor 620 may be implemented in hardware, firmware, or a combination of hardware and software. In some implementations, the processor 620 may include one or more processors capable of being programmed to perform one or more operations or processes described elsewhere herein.

The memory 630 may include volatile and/or nonvolatile memory. For example, the memory 630 may include random access memory (RAM), read only memory (ROM), a hard disk drive, and/or another type of memory (e.g., a flash memory, a magnetic memory, and/or an optical memory). The memory 630 may include internal memory (e.g., RAM, ROM, or a hard disk drive) and/or removable memory (e.g., removable via a universal serial bus connection). The memory 630 may be a non-transitory computer-readable medium. The memory 630 may store information, one or more instructions, and/or software (e.g., one or more software applications) related to the operation of the device 600. In some implementations, the memory 630 may include one or more memories that are coupled (e.g., communicatively coupled) to one or more processors (e.g., processor 620), such as via the bus 610. Communicative coupling between a processor 620 and a memory 630 may enable the processor 620 to read and/or process information stored in the memory 630 and/or to store information in the memory 630.

The input component 640 may enable the device 600 to receive input, such as user input and/or sensed input. For example, the input component 640 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 650 may enable the device 600 to provide output, such as via a display, a speaker, and/or a light-emitting diode. The communication component 660 may enable the device 600 to communicate with other devices via a wired connection and/or a wireless connection. For example, the communication component 660 may include a receiver, a transmitter, a transceiver, a modem, a network interface card, and/or an antenna.

The device 600 may perform one or more operations or processes described herein. For example, a non-transitory computer-readable medium (e.g., memory 630) may store a set of instructions (e.g., one or more instructions or code) for execution by the processor 620. The processor 620 may execute the set of instructions to perform one or more operations or processes described herein. In some implementations, execution of the set of instructions, by one or more processors 620, causes the one or more processors 620 and/or the device 600 to perform one or more operations or processes described herein. In some implementations, hardwired circuitry may be used instead of or in combination with the instructions to perform one or more operations or processes described herein. Additionally, or alternatively, the processor 620 may be configured to perform one or more operations or processes described herein. Thus, implementations described herein are not limited to any specific combination of hardware circuitry and software.

The number and arrangement of components shown in FIG. 6 are provided as an example. The device 600 may include additional components, fewer components, different components, or differently arranged components than those shown in FIG. 6. Additionally, or alternatively, a set of components (e.g., one or more components) of the device 600 may perform one or more functions described as being performed by another set of components of the device 600.

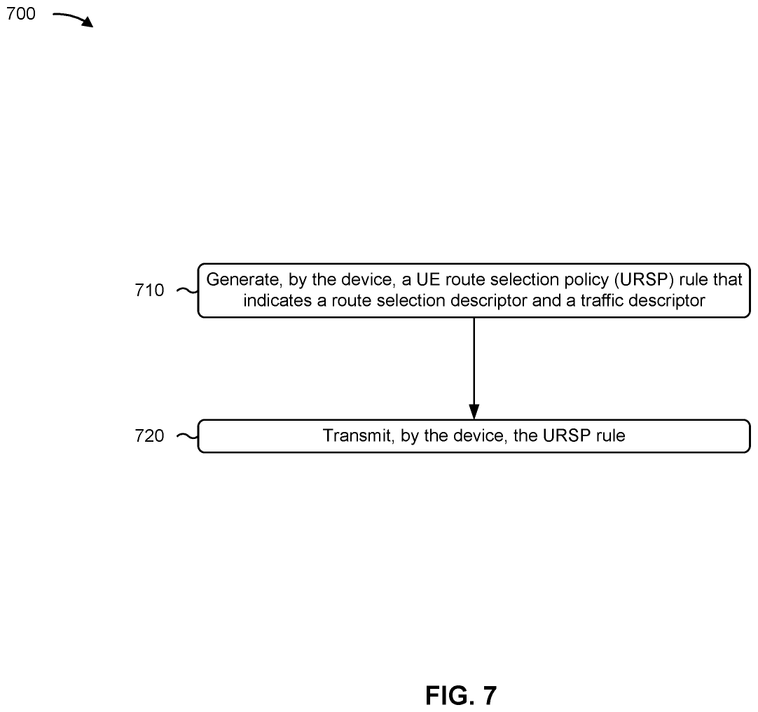

FIG. 7 is a flowchart of an example process 700 associated with receiving route selection policies with CN type indicators. In some implementations, one or more process blocks of FIG. 7 may be performed by a device (device 600), such as a UE (e.g., UE 102), a RAN (e.g., RAN 104), an AMF (e.g., AMF 106), or a PCF (e.g., PCF 108). In some implementations, one or more process blocks of FIG. 7 may be performed by another device or a group of devices separate from or including the device. Additionally, or alternatively, one or more process blocks of FIG. 7 may be performed by one or more components of device 600, such as processor 620, memory 630, input component 640, output component 650, and/or communication component 660.

As shown in FIG. 7, process 700 may include generating a URSP rule that indicates a route selection descriptor and a traffic descriptor, and one of the route selection descriptor or the traffic descriptor indicates a CN type associated with the URSP rule (block 710). The CN type may indicate a value associated with a 5GCN, such that the URSP rule may be associated with the 5GCN. The CN type may indicate a value associated with an EPS, such that the URSP rule may be associated with the EPS. The route selection descriptor may also indicate an S-NSSAI and/or a DNN. The URSP rule may be based on subscription information. Further, the URSP rule may be received as part of a configuration update.

As shown in FIG. 7, process 700 may include transmitting the URSP rule (block 720). A UE may receive the URSP rule from a PCF via a RAN and an AMF. The UE may perform traffic routing based on the URSP rule. The UE, when performing the traffic routing, may establish a PDN session for a matching application based on the CN type. In other words, the UE may establish the PDN session for the matching application based on 5GCN. Alternatively, the UE may establish the PDN session for the matching application based on EPS.

Although FIG. 7 shows example blocks of process 700, in some implementations, process 700 may include additional blocks, fewer blocks, different blocks, or differently arranged blocks than those depicted in FIG. 7. Additionally, or alternatively, two or more of the blocks of process 700 may be performed in parallel.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
generating, by a device, a user equipment (UE) route selection policy (URSP) rule that indicates a route selection descriptor and a traffic descriptor, and one of the route selection descriptor or the traffic descriptor indicates a core network (CN) type associated with the URSP rule; and
transmitting, by the device, the URSP rule.

2. The method of claim 1, wherein the CN type indicates a value associated with a Fifth Generation core network (5GCN), and the URSP rule is associated with the 5GCN.

3. The method of claim 1, wherein the CN type indicates a value associated with an Evolved Packet System (EPS), and the URSP rule is associated with the EPS.

4. The method of claim 1, wherein traffic is routed based on the URSP rule, and a packet data network (PDN) session is established for a matching application based on the CN type.

5. The method of claim 1, wherein the device is one of a policy control function (PCF), a radio access network (RAN), or an access and mobility management function (AMF).

6. The method of claim 1, wherein the route selection descriptor further indicates one or more of a single network slice selection assistance information (S-NSSAI) or a data network name (DNN).

7. The method of claim 1, wherein the URSP rule is based on subscription information.

8. The method of claim 1, wherein transmitting the URSP rule comprises transmitting a configuration update that indicates the URSP rule.

9. A device, comprising:
one or more processors configured to:
generate a user equipment (UE) route selection policy (URSP) rule that indicates a route selection descriptor and a traffic descriptor, and one of the route selection descriptor or the traffic descriptor indicates a core network (CN) type associated with the URSP rule; and
transmit the URSP rule.

10. The device of claim 9, wherein the CN type indicates a value associated with a Fifth Generation core network (5GCN), and the URSP rule is associated with the 5GCN.

11. The device of claim 9, wherein the CN type indicates a value associated with an Evolved Packet System (EPS), and the URSP rule is associated with the EPS.

12. The device of claim 9, wherein traffic is routed based on the URSP rule, and a packet data network (PDN) session is established for a matching application based on the CN type.

13. The device of claim 9, wherein the device is one of a policy control function (PCF), a radio access network (RAN), or an access and mobility management function (AMF).

14. The device of claim 9, wherein the route selection descriptor further indicates one or more of a single network slice selection assistance information (S-NSSAI) or a data network name (DNN).

15. The device of claim 9, wherein the URSP rule is based on subscription information.

16. The device of claim 9, wherein the one or more processors are configured to transmit the URSP rule based on a configuration update.

17. A non-transitory computer-readable medium storing a set of instructions, the set of instructions comprising:
one or more instructions that, when executed by one or more processors of a device, cause the device to:
generate a user equipment (UE) route selection policy (URSP) rule that indicates a route selection descriptor and a traffic descriptor, and one of the route selection descriptor or the traffic descriptor indicates a core network (CN) type associated with the URSP rule; and
transmit the URSP rule.

18. The non-transitory computer-readable medium of claim 17, wherein the CN type indicates a value associated with a Fifth Generation core network (5GCN), and the URSP rule is associated with the 5GCN.

19. The non-transitory computer-readable medium of claim 17, wherein the CN type indicates a value associated with an Evolved Packet System (EPS), and the URSP rule is associated with the EPS.

20. The non-transitory computer-readable medium of claim 17, wherein traffic is routed based on the URSP rule, and a packet data network (PDN) session is established for a matching application based on the CN type.
